(19) United States
(12) Patent Application Publication
(10) Pub. No.: US 2010/0032060 A1
(43) Pub. Date: Feb. 11, 2010

(54) Process for preparing chromium conversion coatings for magnesium alloys

(75) Inventors: Craig A. Matzdorf, California, MD (US); William C. Nickerson, Hughesville, MD (US); James L. Green, Lusby, MD (US)

Correspondence Address: Department of the Navy;(Naval Air Warfare Center -Aircraft Division), 47076 Lijencreantz Road, B 435, PATUXENT RIVER, MD, 20670, US

(73) Assignee: The U.S. of America as represented by the Secretary of the Navy

(21) Appl. No.: 11/058,715

(22) Filed: Feb. 15, 2005

(51) Int. Cl. C23C 22/24; B32B 15/01

(52) U.S. Cl. 148/247; 148/400

(57) ABSTRACT

Process of coating magnesium alloys to improve the corrosion resistance and adhesive bonding strengths of the alloys. The process comprises treating the magnesium alloys with an acidic aqueous solution comprising, per liter of solution, from about 0.01 to 10 grams of a water soluble trivalent chromium compound, about 0.01 to 10 grams of hexafluorozirconate, about 0.0 to 5.0 grams of at least one hexafluorosilicate and/or a tetrafluoroborate, from about 0.0 to 5.0 grams of at least one water soluble divalent zinc compound and from 0.0 to 10 grams of a water soluble thickener and/or 0.0 to 10 grams of a water soluble surfactant.

### ORIGIN OF INVENTION

The invention described herein was made by employee(s) of the United States Government and may be manufactured and used by or for the Government for governmental purposes without the payment of any royalties thereon or therefor.

### BACKGROUND OF THE INVENTION

### Field of the Invention

This invention relates to a process for preparing zirconium-chromium conversion coatings on magnesium alloys. The process comprises treating said alloys with effective amounts of an acidic aqueous solution containing trivalent chromium compounds, hexafluorozirconates and optionally, tetrafluoroborates and/or hexafluorosilicates, zinc compounds, surfactants, wetting agents and/or thickeners. Current surface treatment or preparation of magnesium alloys is based primarily on two technologies i.e. conversion coatings and anodizing. This invention relates to an alternative to the conversion coating magnesium alloys as detailed in SAE AMS 3171, (Magnesium Alloy, Processes for Pretreatment and Prevention of Corrosion On). Conversion coating technologies using prior processes and compositions are based primarily on the use of hexavalent chromium, a known carcinogen and a target for replacement by the Department of Defense and commercial sectors, worldwide. However, very little research and development has been completed with the focus on developing an alternative conversion coating for magnesium alloys. By using the acidic solutions of this invention, a minimum of 1 to 10 minutes dwell time, for example, yields appreciable color change to the as-deposited coating that ranges from bluish to blue-gray depending on the composition of the aqueous solution and the magnesium alloy being treated. The unreacted solution is then thoroughly rinsed from the treated alloy with tap or deionized water. No additional post-treatments are necessary prior to use. The coating is allowed to dry thoroughly before subsequent coatings are applied such as painting and the like.

More specifically, this invention relates to a process for pretreating or coating magnesium alloys to improve its adhesion-bonding and corrosion-resistant properties. The process comprises treating magnesium alloys with an acidic aqueous solution containing effective amounts of at least one water soluble trivalent chromium compound, a water soluble hexafluorozirconate, and optionally at least one water soluble tetrafluoroborate and/or hexafluorosilicate, at least one water soluble divalent zinc compound, and effective amounts of water soluble thickeners and/or water soluble surfactants.

More specifically, magnesium alloys are generally treated by employing a variety of processes and compositions. Current high-performance treatments for magnesium alloys are based on hexavalent chromium chemistry. However, hexavalent chromium is highly toxic and a known carcinogen. As a result, the solutions used to deposit these protective coatings and the coating per se are toxic. However, these hexavalent chromium films or coatings, provide outstanding adhesion, and improved corrosion resistance in comparison to the untreated magnesium alloys.

For these reasons, the environmental laws, executive orders, and local occupational, safety, and health (OSH) regulations are driving military and commercial users to search for treatments free of hexavalent chromium. In the case of magnesium alloys, the base metal is relatively non-toxic. However, with the addition of hexavalent chromium all of the components become toxic. While some of the other coatings or treatments may not contain hexavalent chromium, their technical performance is inferior to the hexavalent chromium-based coatings. Moreover, the use of hexavalent chromium treatments is becoming more expensive as regulations tighten. In addition, the costs of these chromium coatings may become prohibitive with future restrictions imposed by the EPA. Thus, while existing hexavalent chromium treatments are outstanding in their technical performance in that they provide enhanced corrosion protection and adhesion bonding e.g. for paint and other coatings at low application cost, from a life-cycle cost, environmental, and OSH perspective, hexavalent chromium coatings are considered detrimental for people and the environment.

### SUMMARY OF THE INVENTION

This invention relates to a process for preparing zirconium-chromium conversion coatings on magnesium alloys at ambient temperatures or higher e.g. ranging up to about 120° F. More specifically, this invention relates to a process of preparing conversion coatings on magnesium alloys to improve its corrosion-resistance and adhesion-bonding properties. The trivalent chromium process (TCP) of this invention comprises an acidic aqueous solution having a pH ranging from about 2.5 to 5.5 and preferably 3.7 to 4.0, and per liter of said acidic solution, from about 0.01 to 10 grams of a water-soluble trivalent chromium compound, about 0.01 to 10 grams of a hexafluorozirconate, from 0.0 to 5.0 grams of at least one fluorocompound selected from the group consisting of tetrafluoroborates, hexafluorosilicates and various combinations or mixtures thereof in any ratio, from 0.0 to 5.0 grams of at least one water soluble divalent zinc compound, from 0.0 to 10 grams and preferable 0.5 to 1.5 grams of at least one water-soluble thickener, and/or from 0.0 to 10 and preferably 0.5 to 1.5 grams of at least one water-soluble non-ionic, cationic or anionic surfactant or wetting agent.

It is therefore an object of this invention to provide an acidic aqueous solution comprising trivalent chromium compounds, hexafluorozirconates, and tetrafluoroborates and/or hexafluorosilicates for treating magnesium alloys to improve its adhesion and corrosion-resistance properties.

It is another object of this invention to provide a stable acidic aqueous solution having a pH ranging from about 2.5 to 5.5 which comprises a trivalent chromium salt and hexafluorozirconates for preparing a coating on magnesium alloys.

It is a further object of this invention to provide a stable acidic aqueous solution having a pH ranging from about 3.7 to 4.0 comprising trivalent chromium for treating magnesium alloys at about room temperature and higher wherein said acidic solution contains substantially no hexavalent chromium.

These and other object of the invention will become apparent by reference to the detailed description when considered in conjunction with the accompanying FIGS. 1-5 (photos).

### DESCRIPTION OF THE DRAWINGS

FIG. 1 is a photo of Mg AZ91C-T6—Clockwise from lower right, 5, 10, 15, & 25 minutes immersion in ambient TCP using a chromic acid pickle.

FIG. 2 is a photo of Mg AZ91C-T6—Clockwise from lower right, 5, 10, 15, & 25 minutes immersion in ambient TCP using a fluorosilicilic/sulfuric acid pickle.

FIG. 3 is a photo of Mg ZE41A-T5—Clockwise from lower right, 5, 10, 15, & 25 minutes immersion in ambient TCP using a chromic acid pickle.

FIG. 4 is a photo of Mg ZE41A-T5—Clockwise from lower right, 5, 10, 15, & 25 minutes immersion in ambient TCP using a fluorosilicilic/sulfuric acid pickle.

FIG. 5 is a photo of Mg ZE41A-T5—ASTM B117—3 hours Dow™ 7 process using a chromic acid pickle, 30 minutes immersion in boiling potassium dichromate and calcium fluoride solution.

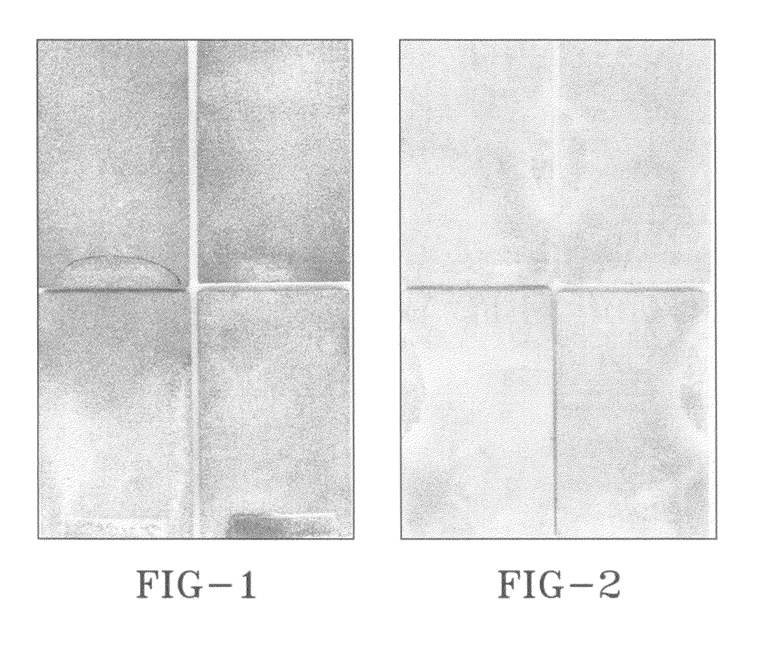

FIGS. 1 and 2 are photos (each showing 4 panels) describing the performance of TCP on AZ91C magnesium alloy with two different processes. The first process uses a chromate-based “pickle” or deoxidizer. The second process uses a non-chromate pickle. It is evident from FIGS. 1 and 2 (photos) that regardless of the immersion time in TCP, the TCP deposited coating using the non-chromate pickle is superior.

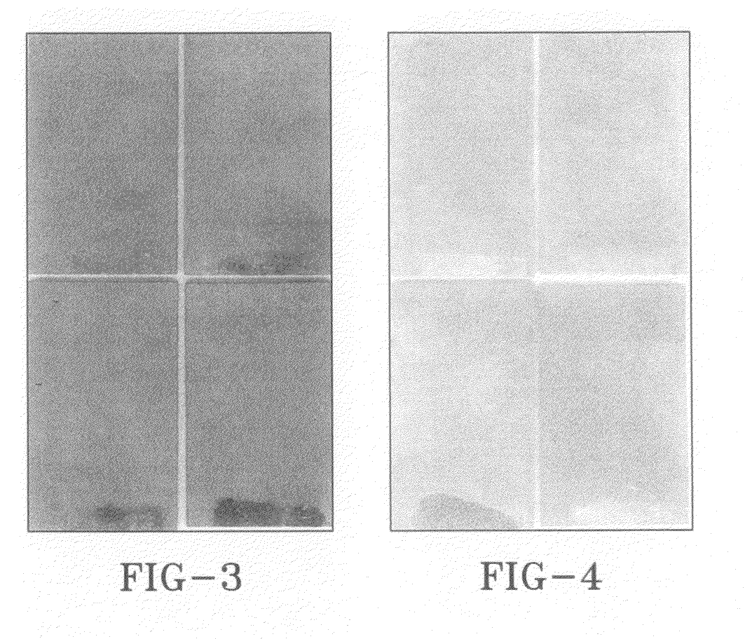

FIGS. 3 and 4 are photos showing the same process as above for FIGS. 1 and 2, but with a ZE41A magnesium alloy. It is clear from FIGS. 1, 2, 3 and 4 that the TCP deposited coatings using the non-chromate pickle performs best regardless of immersion times.

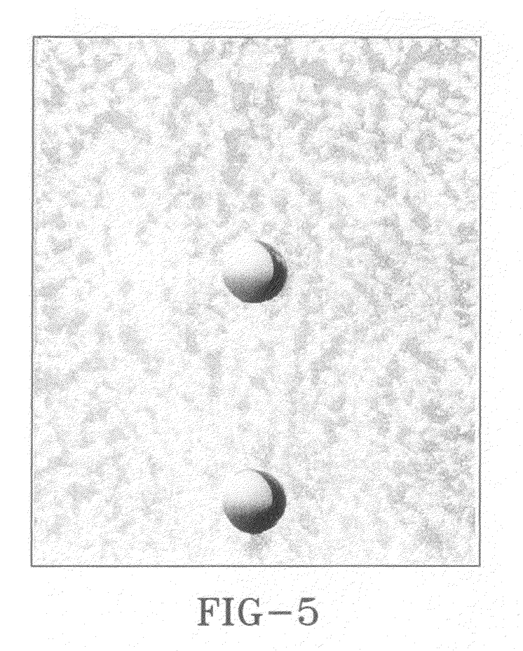

FIG. 5 shows a panel of ZE41A alloy coated with the Dow-7 process (based on hexavalent chromium chemistries in the treating process and in the wash) and yielding a hexavalent chromium conversion coating on the magnesium alloy. It is evident from FIG. 5 (photo) that the TCP coatings on ZE41A as described herein shows that TCP is superior to the standard Dow-7 hexavalent chromium conversion coating. In addition, the TCP process only required 5 to 20 minutes immersion in ambient temperature solutions, whereas the Dow-7 process requires immersion in boiling conversion coating solutions for 30 minutes. The TCP process not only offers better corrosion protection with a hexavalent chromium-free process and coating, but also the process is less costly due to the shorter time required and the elimination of elevated heating requirements.

### DETAILED DESCRIPTION OF THE INVENTION

This invention relates to the process of using an acidic aqueous solution having a pH ranging from about 2.5 to 5.5, and preferably from about 2.5 to 4.5 or 3.7 to 4.0 for preparing a conversion coating on magnesium alloys to improve the adhesion bonding and corrosion-resistance properties of the alloys. The process comprises preparing the coating by using an acidic aqueous solution at temperatures ranging up to about 120° F. which comprises from about 0.01 to 10 grams and preferably from about 1.0 to 5.0 grams e.g. 3.0 grams of at least one water soluble trivalent chromium compound e.g. chromium sulfate, about 0.01 to 10 grams and preferably about 1.0 to 5.0 grams e.g. 4.0 grams of at least one alkali metal hexafluorozirconate, about 0.0 to 5.0 grams and preferably from about 0.12 to 1.2 grams e.g. 0.12 to 2.4 grams of at least one fluorocompound selected from the group consisting of alkali metal tetrafluoroborates, alkali metal hexafluorosilicates and various mixtures or combinations thereof in any ratio, and from about 0.0 to 5.0 grams and preferably 1.0 to 2.0 or 0.05 to 2.0 grams of at least one divalent zinc compound such as zinc sulfate.

In some processes, depending on the physical characteristics of the magnesium alloy e.g. the physical size of the magnesium substrate, a novel feature is the addition of a thickener to the solution that aids in optimum film formation during spray and wipe-on applications by slowing down solution evaporation. This also mitigates the formation of powdery deposits that degrade paint adhesion. In addition, the addition of thickeners aids in proper film formation during large area applications and mitigates the diluent effect of rinse water remaining on the substrate during processing from previous steps. This feature yields films that have no streaks and are better in coloration and corrosion protection. The water soluble thickeners such as the cellulose compounds are present in the acidic aqueous solution in amounts ranging from about 0.0 to 10 grams per liter and preferably from 0.0 to 2.0 grams and more preferably from 0.5 to 1.5 e.g., or about 1.0 gram per liter of the aqueous solution.

Depending on the characteristics of the magnesium alloy, an effective but small amount of at least one water-soluble surfactant or wetting agent can be added to the acidic solution in amounts ranging from about 0.0 to 10 grams and preferably from 0.0 to 2.0 grams and more preferably from 0.5 to 1.5 grams e.g. 1.0 gram per liter of the acidic solution. A mixture of the thickener and surfactant can be added to the solution in amounts ranging from about 0.0 to 10 grams in any ratio. There are many water soluble surfactants known in the prior art and therefore for purpose of this invention the surfactants are selected from the group consisting of non-ionic, cationic and anionic surfactants.

The trivalent chromium is added to the solution as a water-soluble trivalent chromium compound, preferably as a trivalent chromium salt. Specifically, in formulating the acidic aqueous solutions of this invention, the chromium salt can be added conveniently to the solution in its water soluble form provided the valence of the chromium is plus 3. For example, some preferred chromium compounds are incorporated in the solution in the form of Cr₂(SO₄)₃, (NH₄)Cr(SO₄)₂ or KCr(SO₄)₂ and various mixtures of these compounds. A preferred trivalent chromium salt concentration is within the range of about 1.0 to 5.0 grams or 3.0 grams per liter of the aqueous solution. It has been found that particularly good results are obtained from these processes when the trivalent chromium compound is present in solution in the preferred ranges. The preferred metal fluorozirconate addition to the solution ranges from about 1.0 to 5.0 grams or about 4.0 grams per liter of solution.

In some treatments, the alkali metal tetrafluoroborates and/or hexafluorosilicates can be added to the acidic solutions in amounts as low as 0.01 grams per liter up to the solubility limits of the compounds. For example, about 50% weight percent of the fluorosilicate is added based on the weight of the fluorozirconate. In other words, for 8.0 grams per liter of the fluorozirconate salt, about 4.0 grams per liter of fluorosilicate is added to the solution. An alternative is to add about 0.01 to 100 weight percent of the fluoroborate salt based on the weight of the fluorozirconate salt. For example, about 1.0 to 10 weight percent of the fluoroborate salt can be added based on the weight of the fluorozirconate salt. A specific example comprises about 4.0 grams per liter of potassium hexafluorozirconate, about 3.0 grams per liter of chromium III sulfate basic, about 1.0 to 2.0 grams per liter of divalent zinc sulfate and about 0.12 to 0.24 grams per liter of potassium tetrafluoroborate. An important result of the addition of the stabilizing additives i.e. the fluoroborates and/or fluorosilicates is that the solution is stable while the pH is maintained between about 2.5 and 5.5. However, in some examples the solutions may require small adjustments to the pH by the addition of effective amounts of a dilute acid or base to maintain the pH in the range of about 2.5 to 5.5 and preferably from 2.5 to 4.5 or from 3.7 to 4.0.

The solution may contain at least one divalent zinc compound to improve the color and corrosion protection of the coatings compared to compositions that do not contain zinc. The components of the solution are mixed together in water and can be used with no further chemical manipulation. The amount of the zinc compounds can be varied to adjust the color imparted to the coating, from as little as about 0.001 grams per liter up to 5.0 grams per liter e.g. 1.0 to 2.0 or 0.05 to 2.0 grams of Zinc²+cation. The divalent zinc can be supplied by any chemical compound i.e. a salt that dissolves in water and is compatible with the other components in the solution. Divalent compounds that are water soluble at the required concentrations preferably include, for example, zinc acetate, zinc telluride, zinc tetrafluoroborate, zinc molybdate, zinc hexafluorosilicate, zinc sulfate and the like or any combination thereof in any ratio.

The coating of the magnesium alloys can be carried out at various temperatures including the temperature of the solution which ranges from ambient e.g. from about room temperature up to about 120° F. or up to about 200° F. Room temperature is preferred, however, in that this eliminates the necessity for heating equipment. The coating may be air dried by any of the methods known in the art, for example, oven drying, forced air drying, exposure to infra-red lamps, and the like. For purposes of this invention, the term “magnesium alloys” is intended to include any known magnesium alloy containing effective amounts of various other metals.

The following Examples illustrate the stable coating solutions of this invention, and the method of using the solutions in providing color recognition, improved adhesion bonding and corrosion-resistant coatings for magnesium alloys.

### Example 1

A stable acidic aqueous solution having a pH ranging from about 3.4 to 4.0 for treating magnesium alloys to provide a corrosion-resistant and a color-recognized coating thereon comprises, per liter of solution, about 3.0 grams of trivalent chromium sulfate basic, about 4.0 grams of potassium hexafluorozirconate and about 1.0 gram divalent zinc sulfate.

### Example 2

A stable acidic aqueous solution for treating magnesium alloys to improve the adhesion bonding and corrosion-resistant which comprises, per liter of solution, about 3.0 grams of trivalent chromium sulfate basic, and about 4.0 grams of potassium hexafluorozirconate.

### Example 3

The composition of Example 2 including about 0.12 grams of potassium tetrafluoroborate.

### Example 4

A stable acidic aqueous solution for treating magnesium alloys to provide a corrosion-resistant and a color recognized coating thereon comprises, per liter of solution, about 3.0 grams of trivalent chromium sulfate basic, about 4.0 grams of potassium hexafluorozirconate, about 0.12 grams of potassium tetrafluoroborate and about 2.0 grams of divalent zinc sulfate.

The coatings of this invention can be deposited on the alloys using any pickling and activation process disclosed in SAE-AMS-M-3171, the disclosure of which is added hereto by reference, followed by immersion in TCP or a TCP color solution, at ambient to 120° F., for about 3-25 minutes. The optimal corrosion performance and adhesion bonding can be achieved at ambient, i.e. 70-80° F., for about 5-15 minutes. This process deposits a corrosion resistant film or coating with superior adhesion for paint and other subsequent coatings when compared, for example, with a Dow 7′ hexavalent chromium process using the same cleaning, pickling, and activation chemicals. The as-deposited film or coating also yields a visualized color change to the surface of the magnesium alloy.

The pickling and activation process for the alloy was accomplished by two methods; the first being the conventional chromic acid pickle containing hexavalent chromium; and the second containing no hexavalent chromium at any step in the process. The magnesium alloys are cleaned with an alkaline, non-etching cleaner at 140° F. for about 10 minutes and then rinsed. Pickled with 180 g/L CrO3 (chromic acid) solution at 180-200° F. for about 10 minutes. Activated with a 50 g/L NH4F—HF (ammonium bifluoride) solution at ambient temperature for about 5 minutes. Rinsed and then immerse in a TCP acid solution (Examples 1-3) for about 5 minutes at ambient temperature and rinsed.

Alternately, following the cleaning step, which is the same as in the above process; the magnesium alloy is pickled with a dilute solution of fluorosilicilic acid, sulfuric acid, or tetrafluoroboric acid at ambient temperatures for about 10 minutes. Various mixes of these acids will work, particularly a dilute solution of a 3/1 mix of fluorosilicilic and sulfuric acid. The alloy is activated as in the first process, and then immerse in TCP (Examples 1-4) as in the first process. This second process not only eliminates all hexavalent chromium from the magnesium alloy pretreatment process, but also produces TCP films or coatings with greater corrosion resistance when compared to those coatings produced with a chromic acid pickle.

For example, compare the pull-off adhesion results for TCP treatments of this invention as compared to the Dow™ hexavalent chromium process. All panels 3″×5″ Mg ZE41A-T5 were prepared according to SAE-AMS-M-3171 Ty III process in Turco HTC alkaline cleaner, 10 minutes immersion @ 140° F., 150 g/L chromic acid pickle, 10 minutes immersion @ 190° F., then 50 g/L ammonium bifluoride activation, and 5 minutes immersion @ ambient (72° F.). The control panels were then pretreated with 180 g/l potassium dichromate, about 3.0 g/l calcium fluoride solution, and 30 minutes immersion @ boiling (210°+F.). The non-hexavalent chromium TCP panels were pretreated with a solution of 4 g/l potassium hexafluorozirconate, and about 3.0 μl of basic chromium sulfate with about 5 minutes immersion @ ambient (72° F.).

The panels were allowed to air dry for 24 hours before being primed and painted. The paint system was allowed to cure for 14 days before the adhesion testing began. The pull-off adhesion test was conducted in accordance with ASTM D 4541-95. Table I describes the panel preparation.

TABLE I

| Adhesive Type | Cyanoacrylate |
|---|---|
| Cure time (hours) | 24 |
| Temperature (c.) | 50 |
| Percent Relative Humidity | 0 |
| Substrate Materials | Mg ZE41A @ 0.25 |
| and Nominal Thickness (in) | |
| Substrate Surface Profile | As Received (Mill or Cast Finish) |
| Pretreatments | TCP (NAVAIR) |
| Types | SAE-AMS-M-3171 TY III (Mg) |
| Primers | MIL-PRF-23377C |
| | MIL-PRF-85582N/C |
| Topcoats | MIL-C-46168 |
| | MIL-C-53039 |
| | MIL-DTL-64159 Type II |

Table II gives the results of the adhesion tests. The reported numbers are the average of 30 measurements, 6 pull-offs per panel for each of the 5 panel set.

TABLE II

| | | | | 30 | |
|---|---|---|---|---|---|
| Series | | | | measurement | STD |
| No. | Pretreatment | Primer | Topcoat | Average | Dev |
| 27 | Dow 7 chromate | MIL-PRF-23377C | MIL-P-46169-IV | 1142 | 180.33 |
| 28 | Dow 7 chromate | MIL-PRF-85582N | MIL-P-53039-I | 960 | 163.37 |
| 29 | Dow 7 chromate | MIL-PRF-85582C | MIL-P-64159-II | 817.67 | 156.18 |
| 30 | Dow 7 chromate | MIL-PRF-85582N | MIL-P-64159-II | 885.33 | 127.3 |
| 42 | TCP | MIL-PRF-85582N | MIL-P-64159-II | 2187.33 | 410.05 |

Table II demonstrates a 2 to 2.5 fold improvement in the pull-off adhesion test using the TCP coatings of this invention in comparison to the Dow-7 chromate conversion coating on ZE41A alloy. This improvement, in adhesion, helps to improve the corrosion resistance of magnesium alloy components, e.g. painted magnesium alloy substrates.

For purposes of this invention, the water soluble surfactants can be added to the trivalent chromium solutions in amounts ranging from about 0 to 10 grams per liter and preferably 0.5 to about 1.5 grams per liter. The surfactants are added to the aqueous solution to provide better wetting properties by lowering the surface tension thereby insuring complete coverage, and a more uniform film on the magnesium substrate. The surfactants include at least one water soluble compound selected from the group consisting of non-ionic, anionic, and cationic surfactants. Some of the better known water soluble surfactants include the monocarboxyl imidoazoline, alkylsulfate sodium salts (DUPONOL®), tridecyloxy poly(alkyleneoxy ethanol), ethoxylated or propoxylated alkyl phenol (IGEPAL®), alkyl sulfonamides, alkaryl sulfonates, palmitic alkanol amides (CENTROL®), octylphenyl polyethoxy ethanol (TRITON®), sorbitan monopalmitate (SPAN®), dodecylphenyl polyethylene glycol ether (e.g. TERGITROL®), alkyl pyrrolidone, polyalkoxylated fatty acid esters, alkylbenzene sulfonates and mixtures thereof. Other known water soluble surfactants include the alkylphenol alkoxylates, preferably the nonylphenol ethoxylates, the anionic surfactants, and adducts of ethylene oxide with fatty amines; also see the publication: “Surfactants and Detersive Systems”, published by John Wiley & Sops in Kirk-Othmer's Encyclopedia of Chemical Technology, 3′ Ed.

When large surfaces do not permit immersion or where vertical surfaces are to be sprayed, thickening agents are added to retain the aqueous solution on the surface for sufficient contact time. The thickeners employed are known inorganic and preferably the organic water soluble thickeners are added to the trivalent chromium solutions in effective amounts e.g. at sufficient concentrations ranging from about 0 to 10 grams per liter and preferably 0.5 to 1.5 grams per liter of the acidic solution. Specific examples of some preferred thickeners include the cellulose compounds, e.g. hydroxypropyl cellulose (e.g. Klucel), ethyl cellulose, hydroxyethyl cellulose, hydroxymethyl cellulose, or methyl cellulose and mixtures thereof. Other water soluble inorganic thickeners include colloidal silica, clays such as bentonite, starches, gum arabic, tragacanth, agar and various combinations.

After preparing the magnesium alloy surface to be coated via conventional techniques, the solution can be applied via immersion, spray or wipe-on techniques. The TCP solutions can be used at elevated temperatures ranging up to 65° C. and optimally applied via immersion to further improve the corrosion resistance of the coatings. Solution dwell time ranges from about 1 to 60 minutes, and preferably 5 to 15 minutes at about 80° F., depending on the solution temperature. After dwelling, the remaining solution is then thoroughly rinsed from the magnesium substrate with tap or deionized water. No additional chemical manipulations of the deposited films are necessary for excellent performance. However, an application of a strong oxidizing solution can yield a film with additional corrosion resistance. The additional corrosion resistance is presumed to be due to the formation of hexavalent chromium in the film from the trivalent chromium. The aqueous solutions may be sprayed from a spray tank apparatus designed to replace immersion tanks. This concept also reduces active chemical volume from about 1,000 gallons to about 30 to 50 gallons.

While this invention has been described by a number of specific examples, it is obvious that there are other variations and modifications which can be made without departing from the spirit and scope of the invention as particularly set forth in the appended claims.

1. Process for preparing zirconium-chromium conversion coatings on magnesium alloys to improve the corrosion resistance and adhesive bonding strength which comprises treating the magnesium alloys with an acidic aqueous solution having a pH ranging from about 2.5 to 5.5; said acidic aqueous solution comprising, per liter of solution, from about 0.01 to 10 grams of a trivalent chromium compound, about 0.01 to 10 grams of a hexafluorozirconate, about 0.0 to 5.0 grams of at least one fluorocompound selected from the group consisting of tetrafluoroborates, hexafluorosilicates and mixtures thereof, from about 0.0 to 5.0 grams of at least one divalent zinc compound, from about 0.0 to 10 grams of at least one water soluble thickener and from about 0.0 to 10 grams of at least one water-soluble surfactant.

2. The process of claim 1 wherein the pH of the aqueous solution ranges from about 3.7 to 4.0 and the temperature of the aqueous solution ranges from about ambient to 120° F.

3. The process of claim 1 wherein the trivalent chromium is a water soluble compound ranging from about 1.0 to 5.0 grams, the hexafluorozirconate is a water soluble compound ranging from about 1.0 to 5.0 grams, and the fluorocompounds are water soluble compounds ranging from about 0.12 to 1.2 grams.

4. The process of claim 3 wherein the thickener ranges from about 0.5 to 1.5 grams, the surfactant ranges from about 0.5 to 1.5 grams.

5. Process for coating magnesium alloys to improve the corrosion resistance and adhesive bonding strength which comprises treating the magnesium alloys with an acidic aqueous solution having a pH ranging from about 3.7 to 4.0; said acidic aqueous solution comprising, per liter of solution, from about 1.0 to 5.0 grams of a trivalent chromium salt, about 1.0 to 5.0 grams of an alkali metal hexafluorozirconate, about 0.0 to 5.0 grams of at least one fluorocompound selected from the group consisting of alkali metal tetrafluoroborates, alkali metal hexafluorosilicates and mixtures thereof, from about 0.0 to 5.0 grams of at least one divalent zinc compound, from about 0.0 to 10 grams of at least one water soluble thickener, from 0.0 to 10 grams of at least one water soluble surfactant, and from about 0.0 to 10 grams of a mixture of the thickener and surfactant.

6. The process of claim 5 wherein a mixture of the fluorocompounds are present in the solution in an amount ranging from about 0.12 to 1.2 grams.

7. The process of claim 5 wherein the thickener is a cellulose compound present in the acidic solution in amounts ranging from about 0.5 to 1.5 grams per liter.

8. The process of claim 5 wherein the chromium salt is trivalent chromium sulfate basic.

9. The process of claim 5 wherein the alkali metal zirconate is potassium hexafluorozirconate.

10. The process of claim 5 wherein the trivalent chromium compound ranges from about 1.0 to 5.0 grams, the hexafluorozirconate ranges from about 1.0 to 5.0 grams, and the tetrafluoroborate ranges from about 0.12 to 1.2 grams.

11. The process of claim 5 wherein the chromium salt is trivalent chromium sulfate and the divalent zinc compound is zinc sulfate.

12. The process of claim 10 wherein the thickener is a water soluble cellulose compound ranging from about 0.5 to 1.5 grams.

13. The process of claim 10 wherein the zinc compound is zinc acetate.

14. The process of claim 10 wherein the surfactant is selected from the group consisting of water soluble non-ionic, anionic and cationic surfactants.

15. The process of claim 10 wherein the zinc compound is a divalent zinc sulfate ranging from about 0.001 to 5.0 grams.

16. The process of claim 15 wherein the zinc sulfate is present in the aqueous solution in an amount ranging from about 0.05 to 2.0 grams.

17. The process of claim 15 wherein the chromium salt is chromium sulfate present in the aqueous solution in an amount ranging from 1.0 to 5.0 grams, and the mixture of the alkali metal tetrafluoroborates and hexafluorosilicates are present in the aqueous solution in an amount ranging from about 0.12 to 0.24 grams.

18. The process of claim 17 wherein the zinc sulfate is present in the aqueous solution in an amount ranging from about 0.05 to 2.0 grams.

19. The coated magnesium alloys of claim 1.

20. The coated magnesium alloys of claim 5.
